(19) United States
(12) Patent Application Publication
(10) Pub. No.: US 2024/0346418 A1
(43) Pub. Date: Oct. 17, 2024

(54) METHOD AND APPARATUS TO EXTRACT CLIENT DATA WITH CONTEXT USING ENTERPRISE KNOWLEDGE GRAPH FRAMEWORK

(71) Applicant: PricewaterhouseCoopers LLP, New York, NY (US)

(72) Inventors: Chung-Sheng LI, Scarsdale, NY (US); Winnie CHENG, West New York, NJ (US); Mark John FLAVELL, Madison, NJ (US); Nicholas John HAMER, Tampa, FL (US); Rhodri DAVIES, Tampa, FL (US); Craig SHARPLES, West Lafayette, IN (US); Matthew F. CONNELLY, Hingham, MA (US); Shaz HODA, New York, NY (US); Joseph David VOYLES, Louisville, KY (US); Scott LIKENS, Austin, TX (US); Kevin Ma LEONG, Newark, NJ (US)

(73) Assignee: PricewaterhouseCoopers LLP, New York, NY (US)

(21) Appl. No.: 18/300,934

(22) Filed: Apr. 14, 2023

(51) Int. Cl. G06Q 10/0635; G06N 5/022; G06N 5/04

(52) U.S. Cl. CPC G06Q 10/0635; G06N 5/022; G06N 5/04

(57) ABSTRACT

A system for generating and inferencing using enterprise knowledge graphs is provided. The system receives first input data related to one or more entities from one or more data sources. The system extracts a first set of data components from the first input data and determines, based upon the extracted data components, a second set of data components. The system identifies one or more relationships between the first set of data components and the second set of data components and generate a knowledge graph comprising a plurality of nodes. A first node of the knowledge graph can represent a first respective data component of the first set of data components and a second node of the knowledge graph can represent a second respective data component of the second set of data components. The first node can be associated with the second node based on an identified relationship between the nodes.

### FIELD

The present disclosure relates generally to systems and methods for extracting data with context, and more specifically to generating and using enterprise knowledge graphs comprising conceptual, structural, and behavioral knowledge associated with the enterprise.

### BACKGROUND

Enterprise knowledge (e.g., various data related to an enterprise) is often accumulated and stored in a siloed manner. The knowledge may be siloed horizontally, for instance, if data is obtained from different data sources, or vertically, for instance, according to different hierarchical complexity levels of data and computation and inference that are computed based on one another. The siloed nature of accumulated enterprise knowledge creates difficulties in leveraging that knowledge across various aspects of the enterprise. For instance, the siloed nature of accumulated enterprise knowledge makes it difficult for auditors to leverage knowledge accumulated in each of these siloes to understand the enterprise as a whole.

An exemplary challenge in the auditing process is that the same process is repeated over and over, but the logic and rules, or in other words, the acquired knowledge associated with enterprise structures and processes in the form of behavioral, structural, and conceptual knowledge is not easily portable from one audit to the next. If knowledge is acquired and stored in one silo, it may not be accessible to auditors seeking to understand data in a different silo. In some cases, the knowledge may not be stored at all as it is simply acquired in narrative form, for instance, during interviews with enterprise personnel. Thus, information defining relationships between various data and processes is lost, leading to inefficiencies and loss in accuracy of the audit.

### SUMMARY

Disclosed herein are methods and systems for constructing, updating, and using enterprise knowledge graphs to determine insights about a respective enterprise. The enterprise knowledge graphs can form an enterprise world model, combining the conceptual, structural, and behavioral knowledge associated with an enterprise. Conceptual knowledge can include taxonomies and ontologies associated with the entity, structural knowledge can include the legal structure of the entity and related entities, and behavioral knowledge can include business processes associated with the entity.

As such, the enterprise knowledge graph can represent the enterprise at three levels: the structural level, behavioral level, and the conceptual level. Data used to create the enterprise knowledge graph may be associated with one or more of the aforementioned categories/levels, and the data can be prelabeled in accordance with these categories, unlabeled in accordance with these categories, or labeled by a system configured to ingest the data from the exogenous and endogenous data sources in accordance with these categories. Additionally, the knowledge graph may include one or more derived components. Derived components may be derived and included in the knowledge graph by performing various processing operations either on the underlying data or on the enterprise knowledge graph itself. One or more processors may be configured to determine what kind of data a given data point is (e.g., whether input data is associated with behavioral, structural, and/or conceptual aspects of the enterprise), and may process the data in accordance with the determined data category.

The enterprise knowledge graphs disclosed herein can be used to represent an enterprise's financial information, business processes, prior audit processes and results, related entities, talent competencies, innovation competencies, visibility profile, and customer sentiment profile, among other characteristics. For instance, an exemplary enterprise knowledge graph as disclosed herein may include a node representing a general ledger trial balance. This node may be traceable to a financial statement knowledge graph interconnected with the overall enterprise knowledge graph. The financial statement knowledge graph may be in turn traceable to underlying financial data and processing associated with that data (e.g., parenthetical explanations describing an asset or liability category, tick marks, etc.). As such, using the knowledge graph, a user (e.g., auditor) can identify and access knowledge acquired during, for instance, a previous audit associated with an enterprise's financial information and use that knowledge to make determinations related to a current audit.

As another example, the enterprise knowledge graphs as disclosed herein may include a node representing a sales invoice. As such, the knowledge graph can be traced to the sales invoice node which may be traceable to the sales invoice data in a database of sales invoice data, which may then be traceable to all of the documents that represent the sales invoice data. By tracing transaction data through the knowledge graph as described above with respect to the sales invoice, a risk assessment or enterprise risk profile can be generated, which may include information related to a risky transaction identified by tracing the sales invoice node to the sales invoice data and documents representing that sales invoice data. The risk assessment may be one of the derived components that are incorporated into the enterprise knowledge graph.

The enterprise knowledge graphs disclosed herein form part of a common knowledge substrate combining the conceptual, structural, and behavioral knowledge associated with an enterprise. The common knowledge substrate disclosed herein can include the following components: (1) knowledge representation (e.g., knowledge graphs, knowledge rules, behavioral models, structural representations (such as maps), and so on); (2) inferencing engines (e.g., rule engines, graph engines, etc., and each knowledge representation may be associated with an inference engine); and knowledge base construction (e.g., automatic or semiautomatic systems and methods for ingesting/extracting knowledge representation from various corpus/data sources.)

The common knowledge substrate provides a mechanism for connecting and interrogating typically siloed data resources and connecting the dots/semantically linking data of different data modalities (e.g., structured data (for instance, from enterprise resource planning (ERP), relational database (RDB), comma separated value (csv), xlsx, etc.), semi-structured data (e.g. XBRL reports), and unstructured data (such as evidence in pdf files or images). The common knowledge substrate allows users (e.g., auditors) interacting with an enterprise knowledge graph to make informed decisions and formulate recommendations by tracking multiple evidence threads through the enterprise knowledge graph. As such, the enterprise knowledge graph can reveal insights about enterprise processes, structures, and so on. For instance, the enterprise knowledge graph may reveal communities reflected by clusters of related individuals in close proximity and distinguishable from other communities/individuals in the overall enterprise knowledge graph. It may further enable visualization of information flow from the flow of business processes/cash flow.

An exemplary method for generating a knowledge graph includes: receiving, by one or more processors, first input data comprising a first set of data components related to one or more entities from one or more data sources; determining, by the one or more processors, based upon the first input data, a second set of data components; identifying, by the one or more processors, one or more relationships between the first set of data components and the second set of data components; and generating a knowledge graph comprising a plurality of nodes, wherein a first node of the knowledge graph represents a first respective data component of the first set of data components and a second node of the knowledge graph represents a second respective data component of the second set of data components, and wherein the first node is associated with the second node, the association defined by one or more of the identified one or more relationships.

In some examples of the method for generating a knowledge graph, the second set of data components comprises a first derived component derived based on a first processing operation performed using the first input data.

In some examples of the method for generating a knowledge graph, the first derived component comprises an entity risk profile associated with a first entity, the entity risk profile determined based on the first input data.

In some examples of the method for generating a knowledge graph, the entity risk profile is constructed based on any one or more of structural knowledge associated with the first entity, conceptual knowledge associated with the first entity, and behavioral knowledge associated with the first entity.

In some examples of the method for generating a knowledge graph, the first processing operation comprises a financial audit operation performed using the first input data.

In some examples, the method for generating a knowledge graph includes determining a third set of data components, wherein the third set of data components comprises the result of a second processing operation performed using the generated knowledge graph; and incorporating the third set of data components into the generated knowledge graph.

In some examples of the method for generating a knowledge graph, the second processing operation is different from the first processing operation.

In some examples, the method for generating a knowledge graph includes determining an insight from the generated knowledge graph, wherein the insight is based on nodes representing the first set of data components, the second set of data components, and the third set of data components.

In some examples of the method for generating a knowledge graph, the first set of data components comprises any one or more of: financial statements, sales orders, subsidiary entity lists, supplier lists, customer lists, employee lists, competitor lists, patent filings, trademark filings, social media posts, purchase orders, sales orders, bills of lading, bank statements, general ledger records, inventory lists, invoices, shipment records, accounts receivable records, accounts payable records, social media posts, and SEC filings.

In some examples the method for generating a knowledge graph includes determining an insight from the generated knowledge graph, wherein the insight is based on nodes representing the first set of data components and the second set of data components.

In some examples of the method for generating a knowledge graph, the first input data comprises data of one or more data modalities, the one or more data modalities comprising an unstructured data modality, a semi-structured data modality, and a structured data modality.

In some examples of the method for generating a knowledge graph, the one or more relationships comprise a one-to-one mapping of all or a subset of all of the first set of data components and the second set of data components.

In some examples of the method for generating a knowledge graph, the one or more relationships comprise a one-to-many mapping of all or a subset of all of the data components of the first set of data components and the second set of data components.

In some examples of the method for generating a knowledge graph, the one or more relationships comprise a many-to-one mapping of all or a subset of all of the data components of the first set of data components and the second set of data components.

In some examples of the method for generating a knowledge graph, the one or more relationships comprise a many-to-many mapping of all or a subset of all of the data components of the first set of data components and the second set of data components.

In some examples of the method for generating a knowledge graph, the first node of the knowledge graph refers to one or more of structural knowledge associated with a first entity of the one or more entities, conceptual knowledge associated with the first entity, and behavioral knowledge associated with the first entity.

In some examples of the method for generating a knowledge graph, the conceptual knowledge associated with the first entity comprises taxonomies and ontologies associated with the first entity.

In some examples of the method for generating a knowledge graph, the structural knowledge associated with the first entity comprises a legal structure of one or more of the first entity and one or more entities related to the first entity.

In some examples of the method for generating a knowledge graph, the behavioral knowledge associated with the first entity comprises one or more business processes associated with the first entity.

In some examples of the method for generating a knowledge graph, an entity of the one or more entities is any one of an individual, a business entity, or a government entity.

In some examples of method for generating a knowledge graph includes receiving second input data related to the one or more entities from the one or more data sources; identifying one or more relationships between the second input data and a node of the generated knowledge graph; and updating the knowledge graph by incorporating the second input data, wherein incorporating the second input data comprises associating the second input data with the node of the generated knowledge graph based on the identified one or more relationships between the second input data and the node of the generated knowledge graph.

In some examples of the method for generating a knowledge graph, the first input data comprises a first set of rules associated with a structure of a first entity and a second set of rules associated with a process of the first entity.

An exemplary system for generating a knowledge graph includes one or more processors configured to cause the system to receive, by one or more processors, first input data including a first set of data components related to one or more entities from one or more data sources; determine, by the one or more processors, based upon the first input data, a second set of data components; identify, by the one or more processors, one or more relationships between the first set of data components and the second set of data components; and generate a knowledge graph comprising a plurality of nodes, wherein a first node of the knowledge graph represents a first respective data component of the first set of data components and a second node of the knowledge graph represents a second respective data component of the second set of data components, and wherein the first node is associated with the second node, the association defined by one or more of the identified one or more relationships.

An exemplary non-transitory computer readable storage medium stores instructions for generating a knowledge graph, the instructions configured to be executed by a system including one or more processors to cause the system to: receive, by one or more processors, first input data including a first set of data components related to one or more entities from one or more data sources; determine, by the one or more processors, based upon the first input data, a second set of data components; identify, by the one or more processors, one or more relationships between the first set of data components and the second set of data components; and generate a knowledge graph comprising a plurality of nodes, wherein a first node of the knowledge graph represents a first respective data component of the first set of data components and a second node of the knowledge graph represents a second respective data component of the second set of data components, and wherein the first node is associated with the second node, the association defined by one or more of the identified one or more relationships.

An exemplary method for interrogating a knowledge graph includes: receiving, by one or more processors, an input query, interrogating, based on the input query, a knowledge graph, wherein the knowledge graph comprises a plurality of nodes, wherein a first node of the knowledge graph represents a first respective data component of a first set of data components and a second node of the knowledge graph represents a second respective data component of a second set of data components, wherein the second set of data components comprises a derived component derived based on a first processing operation performed using one or more data components of the first set of data components, and wherein the first node is associated with the second node, the association represented by one or more relationships identified between the respective first data component and the second respective data component.

In some examples of the method for interrogating a knowledge graph, interrogating the knowledge graph comprises performing a statistical analysis on one or more of the plurality of nodes of the knowledge graph.

In some examples of the method for interrogating a knowledge graph, interrogating the knowledge graph comprises identifying one or more clusters of nodes in the knowledge graph.

In some examples of the method for interrogating a knowledge graph, the one or more clusters of nodes are associated with one or more communities of individuals represented in the knowledge graph.

In some examples of the method for interrogating a knowledge graph, the one or more clusters of nodes are associated with one or more related transactions represented in the knowledge graph.

In some examples, the method for interrogating a knowledge graph includes: generating an output based on interrogating the knowledge graph, wherein output comprises a risk assessment.

In some examples, the method for interrogating a knowledge graph includes: generating an output based on interrogating the knowledge graph, wherein output comprises an audit strategy.

In some examples of the method for interrogating a knowledge graph, the first set of data components comprises data from one or both of an endogenous data source and an exogenous data source, and wherein the first set of data components is associated with a first entity of the one or more entities.

In some examples of the method for interrogating a knowledge graph, the first processing operation comprises an audit operation using one or more data components of the first set of data components.

In some examples of the method for interrogating a knowledge graph, one or more of the plurality of nodes refers to one of structural knowledge associated with a first entity, conceptual knowledge associated with the first entity, and behavioral knowledge associated with the first entity.

In some examples of the method for interrogating a knowledge graph, the structural knowledge comprises an entity relationship graph that indicates one or more relationships between the first entity and one or more different entities.

In some examples of the method for interrogating a knowledge graph, the conceptual knowledge comprises one or more rules associated with the first entity.

In some examples of the method for interrogating a knowledge graph, the behavioral knowledge comprises one or more business processes associated with the first entity.

An exemplary system for interrogating a knowledge graph includes one or more processors configured to cause the system to: receive, by one or more processors, an input query, interrogating, based on the input query, a knowledge graph, wherein the knowledge graph comprises a plurality of nodes, wherein a first node of the knowledge graph represents a first respective data component of a first set of data components and a second node of the knowledge graph represents a second respective data component of a second set of data components, wherein the second set of data components comprises a derived component derived based on a first processing operation performed using one or more data components of the first set of data components, and wherein the first node is associated with the second node, the association represented by one or more relationships identified between the respective first data component and the second respective data component.

An exemplary non-transitory computer readable storage medium stores instructions for interrogating a knowledge graph, the instructions configured to be executed by a system including one or more processors to cause the system to: receive, by one or more processors, an input query, interrogating, based on the input query, a knowledge graph, wherein the knowledge graph comprises a plurality of nodes, wherein a first node of the knowledge graph represents a first respective data component of a first set of data components and a second node of the knowledge graph represents a second respective data component of a second set of data components, wherein the second set of data components comprises a derived component derived based on a first processing operation performed using one or more data components of the first set of data components, and wherein the first node is associated with the second node, the association represented by one or more relationships identified between the respective first data component and the second respective data component.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

FIG. 1 illustrates an exemplary system architecture according to some embodiments.

FIG. 2 illustrates an exemplary method for generating and using a knowledge graph according to some embodiments.

FIG. 3 illustrates an exemplary method for progressively and continuously ingesting data and to construct and augment a knowledge graph according to some embodiments.

FIG. 4 illustrates a method for using the exemplary enterprise knowledge graphs disclosed herein to determine an insight, according to some embodiments.

FIG. 5 illustrates an exemplary method for interrogating a knowledge graph according to some embodiments.

FIG. 6 illustrates an exemplary enterprise knowledge graph according to some embodiments.

FIG. 7 illustrates an exemplary enterprise risk profile according to some examples.

FIG. 8 illustrates an exemplary process and data integrity graph structure that can form part of an enterprise knowledge graph according to some examples.

FIG. 9 illustrates how the common knowledge substrate/enterprise knowledge graphs disclosed herein can be integrated into an overall auditing ecosystem.

FIG. 10 illustrates a knowledge substrate for use in an audit according to some examples.

FIG. 11 illustrates an exemplary computing system according to some embodiments.

### DETAILED DESCRIPTION

As described above, enterprise knowledge is often accumulated and stored in a siloed manner. The knowledge may be siloed horizontally, for instance, if data is obtained from different data sources, or vertically, for instance, according to different hierarchical complexity levels of data and computation and inference that are computed based on one another. The siloed nature of accumulated enterprise knowledge creates difficulties in leveraging that knowledge across various aspects of the enterprise. For instance, it makes it difficult for auditors to leverage knowledge accumulated in each of these siloes to understand the enterprise as a whole.

An exemplary challenge in the auditing process is that the same process is repeated over and over, but the logic and rules, or in other words, the knowledge acquired during each an audit associated with enterprise structures and processes in the form of behavioral, structural, and conceptual knowledge is not easily portable from one audit to the next. If knowledge is acquired and stored in one silo, it may not be accessible to auditors seeking to understand data in a different silo. In some cases, the knowledge may not be stored at all as it is simply acquired in narrative form, for instance, during interviews with enterprise personnel. Thus, information defining relationships between various enterprise data and processes is lost, leading to inefficiencies and loss in accuracy of the audit.

Accordingly, described herein are systems and methods for generating knowledge graphs forming part of a common knowledge substrate and including the conceptual, structural, and behavioral knowledge associated with an enterprise. As described above, the common knowledge substrate disclosed herein can include the following components: (1) knowledge representation (e.g., knowledge graphs, knowledge rules, behavioral models, structural representations (such as maps), and so on); (2) inferencing engines (e.g., rule engines, graph engines, etc., and each knowledge representation may be associated with an inference engine); and knowledge base construction systems and methods (e.g., automatic or semiautomatic systems and methods for ingesting/extracting knowledge representation from various corpus/data sources). The generated knowledge graph can be used to determine various insights about an enterprise which may be highly useful, for instance, in conducting an audit.

The methods for generating enterprise knowledge graphs as described herein may include receiving, by one or more processors, input data including a first set of data components from various data sources and associated with one or more entities. The one or more processors may be configured to determine, based on the first input data, a second set of data components and identify one or more relationships between the first set of data components and the second set of data components. The one or more processors may further be configured to generate a knowledge graph comprising a plurality of nodes, wherein a first node of the knowledge graph represents a first respective data component of the first set of data components and a second node of the knowledge graph represents a second respective data component of the second set of data components, and wherein the first node is associated with the second node, the association defined by one or more of the identified one or more relationships. Each of the plurality of nodes may refer to one or more types of knowledge associated with an enterprise, for instance, at the conceptual, structural or behavioral level. Further, after generating the knowledge graph, the one or more processors may be configured to derive additional data by processing the knowledge graph and incorporate the additional derived data into the knowledge graph.

The enterprise knowledge graphs generated according to the systems and methods herein may be continuously and progressively constructed as additional data associated with an enterprise or related enterprises is acquired. Each node of the enterprise knowledge graph can represent a derived component resulting from a processing operation performed using data received from the exogenous and endogenous data sources, a derived component resulting from a processing operation performed using the knowledge graph itself, the data itself received from the endogenous and exogenous data sources associated with the conceptual, structural, and behavioral aspects of the enterprise, and so on to include all of the conceptual, structural, and behavioral knowledge associated with an enterprise. At the conceptual level, a node of the enterprise knowledge graph can refer to another knowledge graph or a set of business rules. At the structural level, a node of the enterprise knowledge graph can refer to an entity relationship graph that indicates the relationships between/among entities. At the behavioral level, a node of the enterprise knowledge graph can refer to a business process or a workflow or a dataflow.

Insights related to an enterprise may be determined by traversing between nodes of the knowledge graph along edges of the graph, or through other analysis techniques, such as by performing statistical analysis on one or more nodes in the graph, clustering the nodes of the knowledge graph, identifying clusters or hyperclusters within the knowledge graph, and so on. Different nodes of the enterprise knowledge graph may be associated with different knowledge components of the enterprise (e.g., financial, innovation, talent, etc.). Thus, using a knowledge graph to derive an insight based on the knowledge graph may include traversing between nodes of a knowledge graph representing financial knowledge, related entity knowledge, talent competency knowledge, innovation competency knowledge, visibility profile knowledge, and/or a customer sentiment knowledge.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are accorded the scope consistent with the claims.

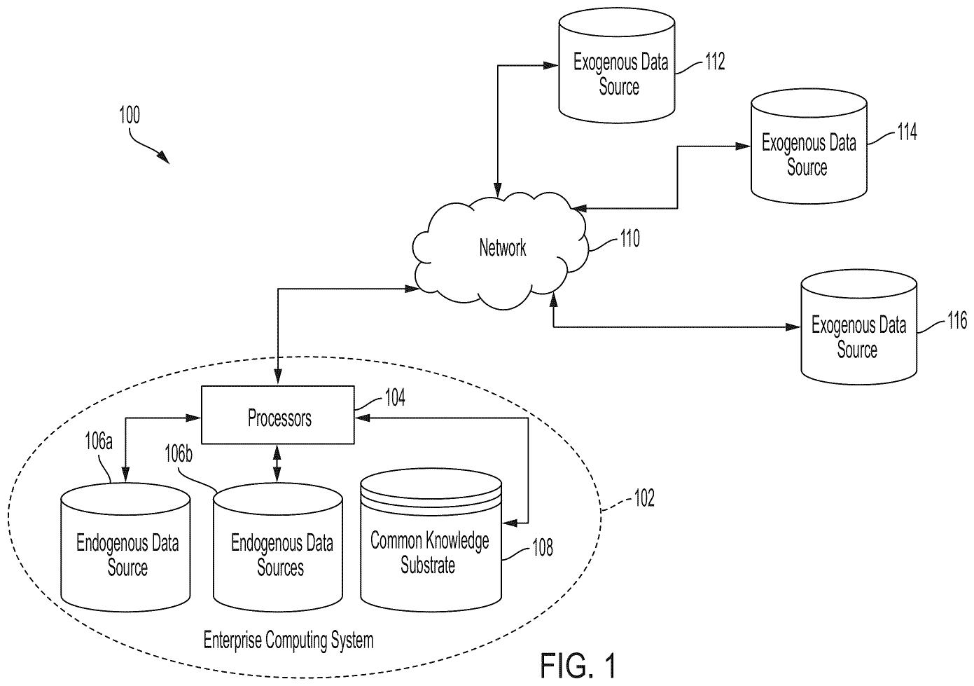

FIG. 1 illustrates an exemplary system 100 for generating a knowledge graph. The system 100 may include an enterprise computing system 102. The enterprise computing system 102 may include one or more processors 104 configured to receive data from endogenous data sources 106a and 106b and exogenous data sources 112, 114, and 116. The endogenous data sources 106a and 106b may include data sources internal to an enterprise computing system 102 and may be communicatively coupled within the enterprise computing system 102 (e.g., by one or more wired or wireless network communication protocols and/or interface(s)) to the one or more processors 104. The exogenous data sources 112, 114, and 116 may be communicatively coupled to the one or more processors 104 of enterprise computing system 102 via network 110. Network 110 may include one or more wired or wireless communication protocols or interfaces for communicatively coupling the processors 104 of enterprise computing system 102 to the exogenous data sources 112, 114, and 116.

Both the endogenous data sources 106a and 106b and exogenous data sources 112, 114, and 116 may include structured data (e.g., relational database (RDB), comma separated value (csv), xlsx, etc.), semi-structured data (e.g., EDI, XML, etc., including XBRL reports), and unstructured data (e.g., pdf, images, text documents, etc.). The endogenous data from endogenous data sources 106a and 106b and exogenous data from exogenous data sources 112, 114, and 116 may include data associated with the conceptual, structural, and behavioral aspects of the enterprise. The conceptual knowledge may include taxonomies and ontologies associated with the entity, the structural knowledge may include the legal structure of the entity and related entities, and the behavioral knowledge may include business processes associated with the entity.

The endogenous data source 106a may include data associated with a first aspect of an enterprise associated with enterprise computing system 102 and endogenous data source 106b may include data associated with a second aspect of the same enterprise associated with enterprise computing system 102. Each respective endogenous data source 106a and 106b may include any one or more of structured, unstructured, and semi-structured data associated with the behavioral, structural, and/or conceptual aspects of the respective enterprise.

The exogenous data sources 112, 114, and 116 may each include data from data sources external to the enterprise computing system 102 associated with the conceptual, structural, and behavioral knowledge associated with the respective enterprise associated with the enterprise computing system 102. The exogenous data sources 112, 114, and 116 may include historical security and exchange commission (SEC) filings (e.g., from EDGAR), a social media platform, a publicly available patent portfolio (e.g., from Patent Center), etc.

The one or more processors 104 may be configured to receive the data from the endogenous data sources 106a and 106b and exogenous data sources 112, 114, and 116 and process said data to generate processed endogenous/exogenous data, including, for example client specific data (e.g., master data), industry specific data (e.g., industry ontology), general data (e.g., shipping terms, FX, MIDA), and policy and rules data (e.g., ASC 606). The one or more processors 104 may be configured to determine what kind of data a given data point is (e.g., whether input data is associated with behavioral, structural, and/or conceptual aspects of the enterprise), and may process the data in accordance with the determined data category.

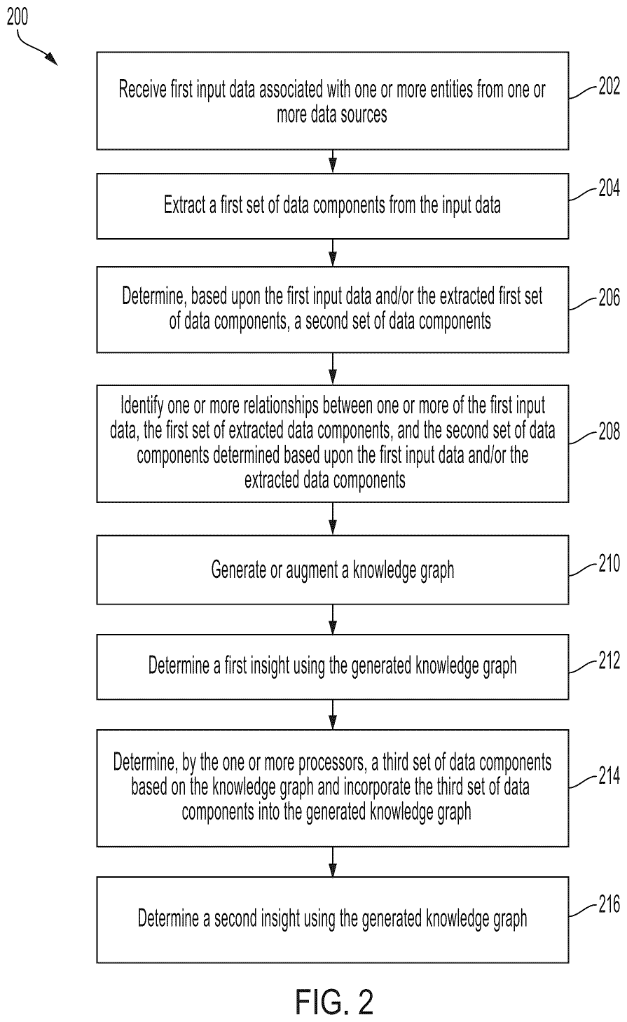

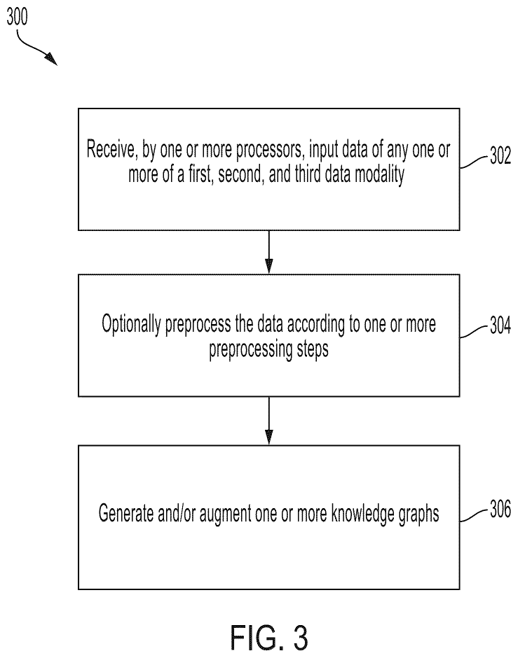

Processing the data may include determining one or more derived components based on the data from the endogenous data sources 106a and 106b and exogenous data sources 112, 114, and 116. The one or more processors 104 may be configured to generate one or more enterprise knowledge graphs comprising the data received and processed, including the derived components determined by processing the data from the endogenous data sources 106a and 106b and exogenous data sources 112, 114, and 116, for instance, substantially as described below with reference to FIGS. 2 and 3. The one or more processors 104 may further be configured to determine one or more derived components based on the generated enterprise knowledge graphs substantially as described below with reference to FIGS. 2 and 3 and to incorporate those components into the existing enterprise knowledge graph.

FIG. 2 illustrates an exemplary method 200 for generating a knowledge graph and using the knowledge graph to derive various insights. The method 200 may begin at step 202, wherein step 202 includes receiving, by one or more processors, first input data associated with one or more entities from one or more data sources. The one or more entities may include the enterprise for which the enterprise knowledge graph is being generated, subsidiary entities, suppliers, customers, employees, competitors, or any other entity that may be associated with the respective enterprise for which the enterprise knowledge graph is being generated. An entity of the one or more entities may be any one of an individual, a business entity, or a government entity. The one or more data sources may be endogenous or exogenous data sources such as those described above with reference to FIG. 1. As such, the data sources may be data held by the enterprise itself or data obtained from external sources such as historical security and exchange commission (SEC) filings, a social media profile, a publicly available patent portfolio, etc. However, it should be understood that the one or more data sources may be any endogenous or exogenous data sources comprising data associated with the respective enterprise.

The data may include any variety of enterprise data. For instance, the data may include financial statements, sales orders, identifiers of subsidiary entities, suppliers, customers, employees, and competitors, patent filings, trademark filings, social media posts, purchase orders, inventory lists, invoices, and so on. The input data may additionally include, for instance, social media posts, SEC filings, and any other variety of public disclosures associated with the entity. It should be understood that the aforementioned data are meant to be exemplary and any data pertinent to a respective enterprise may be included in the input data. As noted, non-public data may be ingested and used in generating the knowledge graph as described further below as well (business processes, financial statement versions, discount rules, etc.), for instance from ERP data.

The input data may be associated with the behavioral, structural, and conceptual aspects of an enterprise. The input data may fall into one or more of the aforementioned categories (structural, conceptual, behavioral aspects of the enterprise). The input data can be prelabeled in accordance with these categories, unlabeled in accordance with these categories, or labeled by the one or more processors configured to ingest the data from the exogenous and endogenous data sources in accordance with these categories. The one or more processors may be configured to determine what kind of data a given data point is (e.g., whether input data is associated with behavioral, structural, and/or conceptual aspects of the enterprise), and may process the data in accordance with the determined data category.

In some examples, the received data may require normalization or contextualization operations to a achieve a common data modality/format. Normalizing the data may be performed by one or more processors of a system carrying out the method 200. The one or more processors may apply one or more normalization and contextualization operations to some or all of the received data and may thereby generate normalized and/or contextualized output data. A normalization and contextualization data processing operation may determine context of an entity and/or may normalize an entity value so that it can be used for subsequent comparison or classification. Examples include (but are not limited to) the following: normalization of customer name data (such as alias, abbreviations, and potentially including parent/sibling/subsidiary when the name is used in the context of payment) based on master customer/vendor data; normalization of address data (e.g., based on geocoding, based on standardized addresses from a postal office, and/or based on customer/vendor data); normalization of product name and SKU based on master product data; normalization of shipping and payment terms based on terms (e.g., based on International Commerce Terms); and/or normalization of currency exchange code (e.g., based on ISO 4217).

Additional examples include normalization of (1) data models (it is often desirable to normalize according to a given data model, such as separate credit/debit columns of a bank statement being transformed into a single column with positive number indicating credit while negative number indicating debit); (2) data semantics (it is often desirable to normalize according to a given taxonomy/ontology, such as the shipping/freight terms according to INCOTERM standard); and (3) data range (normalization often involves adjusting the data range so that the values can be comparable).

After receiving data associated with one or more entities from the one or more data sources at step 202, the method 200 may proceed to step 204. Step 204 may include extracting, by the one or more processors, a first set of data components from the first input data. The one or more processors may be configured to extract any number of data components. In some examples, hundreds, thousands, or millions of data components may be extracted from the input data.

Each of the plurality of data components may be a discrete element of the received data or a subset of elements included in the data received at step 202. For instance, a first data component may be a single purchase order, and a second data component may be a single bank statement. Alternatively or additionally, a first data component may be an accounts receivable chart and a second data component may be an accounts payable chart, each chart including numerous discrete cells containing accounts receivable and accounts payable data. It should be understood that the aforementioned data components are meant to be exemplary and not limiting. Data components within the data received at step 202 may include any variety of textual data, integer data, and so on.

For instance, the plurality of data components may be financial data components like financial statements or financial statement line items (FSLIs) within the financial statements. The data components may include data associated with audit processes such as tick marks, cross references to evidence, cross references to findings and conclusions, cross references to actions to take, cross references to proposed adjustments, cross references to responsible parties, and so on. The components may include data associated with business processes and various subcomponents of the business processes, for instance, credit memos, packing slips, and invoices, associated with the sales return process. The data components may include employee names and titles, subsidiary companies, suppliers, competitors, and so on. As such, the data components extracted at step 204 may include for instance a single datum or may include subsets of data including hundreds, thousands, or millions of datum from the received data.

The plurality of extracted data components may be extracted from the same data source, for instance, an endogenous database comprising data associated with the enterprise. In some examples, a first subset of the plurality of extracted data components includes data components extracted from a first data source of the one or more data sources and a second subset of the plurality of extracted data components includes data from a second data source of the one or more data sources. The one or more data sources may include data in the form of one or more data modalities. As such, a first subset of the plurality of extracted data components may include data of a first data modality and a second subset of the plurality of extracted components may include data of a second data modality. The one or more data modalities may include an unstructured data modality (e.g., pdf, docx, pnp, etc.), a semi-structured data modality (e.g., electronic data interchange (EDI), extensible markup language (XML)), and a structured data modality (e.g., enterprise resource planning (ERP), procurement, work information management system (WIMS), etc.).

After extracting the first set of data components at step 204, the method 200 may proceed to step 206. Step 206 can include determining, by the one or more processors, based upon the first input data and/or the extracted first set of data components, a second set of data components. The second set of data components may be associated with one or more of the structural knowledge, behavioral knowledge, and conceptual knowledge associated with the enterprise. As described above, the conceptual knowledge can include taxonomies and ontologies associated with the entity, the structural knowledge can include the legal structure of the entity and related entities, and the behavioral knowledge can include business processes associated with the entity.

The second set of data components may include a first derived component. The first derived component may be determined by the one or more processors based on one or more of the plurality of extracted components and/or based directly upon the data received at step 202 (i.e., the data may be received in a configuration that allows for omission of the extraction step described above with reference to step 204). The first derived component may include the result of a first processing operation performed based on the first input data and/or one or more of the plurality of extracted data components. As described above with reference to step 204, any number of components (hundreds, thousands, millions, etc. of data components) may be extracted from the received input data. Determining a derived component at step 206 may include determining a derived component based on all or any subset of all of the first input data and/or the plurality of extracted components.

The first processing operation may include performing financial audit operation using one or more of the first set of extracted data components (e.g., vouching, tracing, etc.). The first processing operation may be a risk assessment for determining a level of risk associated with an enterprise or some aspect of the enterprise. The derived component determined at step 208 can thus be used in constructing an enterprise knowledge graph. For instance, as noted above and described further below, a node in the enterprise knowledge graph can refer to an end-to-end business process (such as vouching & tracing) or a data processing flow (such as an extract-transform-load).

After determining, based on the first input data and/or the extracted first set of data components, a second set of data components at step 206, the method 200 may proceed to step 208. Step 208 may include identifying, by the one or more processors, one or more relationships between one or more of the first input data, the first set of extracted data components and the second set of data components determined based upon the first input data and/or the extracted data components. For instance, the one or more processors may be configured to identify one or more relationships between each of the plurality of extracted components used to determine the first derived component and the first derived component itself.

The one or more processors may also be configured to identify one or more additional relationships between all or a subset of all of the first input data and/or the extracted data components and all or a subset of all of the second set of data components including the first derived component. The one or more processors may be configured to identify one or more relationships between each respective component of the plurality of extracted components and each of the other respective components of the plurality of extracted components.

The one or more relationships may include a one-to-one mapping of all or a subset of all of the first input data and/or the plurality of extracted data components used to determine the first derived component and the first derived component itself. The one or more relationships may include a one-to-many mapping of all or a subset of all of the first input data and/or the plurality of extracted data components used to determine the first derived component, and the first derived component itself. The one or more relationships may include a many-to-one mapping of all or a subset of all of the first input data and/or the plurality of extracted data components used to determine the first derived component components, and the first derived component itself.

A relationship of the one or more identified relationships may be a logical relationship (e.g., “and,” “or” or “not”). A relationship of the one or more relationships may be a binary relationship, an integer relationship, or a multidimensional relationship representing linkages across different types of nodes. The one or more relationships may include any type of relationship that can define an edge of a knowledge graph. As such, the edge between nodes of a knowledge graph can describe the relationship between nodes. As an example, the relationship between a node that describes an order-to-cash business process and the node that describes the purchase order and bank statements is “supporting evidence”, while the relationship between the node describing the order-to-cash business process and the node describing the customer data is the customer master data.

For instance, in an exemplary financial statement knowledge graph, a series of nodes may be connected as follows. A first node “report” may be connected by an edge “has (0 to many)” to a second node “reporting style” to represent a relationship between the first and second node indicating that a report has zero to many reporting styles. The second node “reporting style” may in turn be connected by edge “has (0 to many)” to a to a third node “consistency crosscheck rule” to represent a similar relationship between the second and third node. The third node, in turn may be connected by edge “type of” to a fourth node “input type rule” to indicate that the consistency crosscheck rule is a type of input type rule.

In some examples, after identifying one or more relationships between one or more of the first input data and/or the first set of extracted data components and the second set of data components determined based upon the first input data and/or the extracted data components. at step 208, the method 200 may proceed to step 210. Step 210 may include generating or augmenting, by the one or more processors, a knowledge graph including a plurality of nodes. Each of the plurality of nodes may respectively represent one or more components from each of the first and second set of data components. As such, each of the plurality of extracted data components and each respective derived component may form nodes of the knowledge graph, and each node may be interconnected with one or more of the other nodes by edges, wherein the edges represent the one or more identified relationships described above. For instance, the knowledge graph may include a first node of the knowledge graph that represents a first respective component of the plurality of extracted components that was used to derive the first derived component, and a second node that represents the first derived component. The first node can be associated with the second node, and the association may represent one or more of the identified one or more relationships.

In some examples, each node of the enterprise knowledge graph may refer to a type of knowledge, potentially at the conceptual, structural or behavioral level. At the conceptual level, a node could refer to another knowledge graph or a set of business rules. At the structural level, a node could refer to an entity relationship graph that indicates the relationships between/among entities. At the behavioral level, a node could refer to a business process or a workflow or a dataflow. Each node may be associated with the input data received at step 202 and/or one or more of the one or more derived components determined at step 206. For instance, a first node may be associated with a first component of the input data and a second node may be associated with one of the derived components determined based on the first component of the input data. The first and second nodes may be associated with each other based on an identified relationship between the first and second nodes. The relationship may be represented by an edge of the knowledge graph.

After generating or augmenting the knowledge graph at step 210, the method 200 may proceed to step 212, wherein step 212 includes determining, by the one or more processors, a first insight using the generated knowledge graph. The first insight may be generated based on nodes representing one or both of the first and second set of data components. The first insight can be based on any one or more of the node(s) representing the first input data and/or extracted data components from the first input data, and/or the node(s) representing the first derived component.

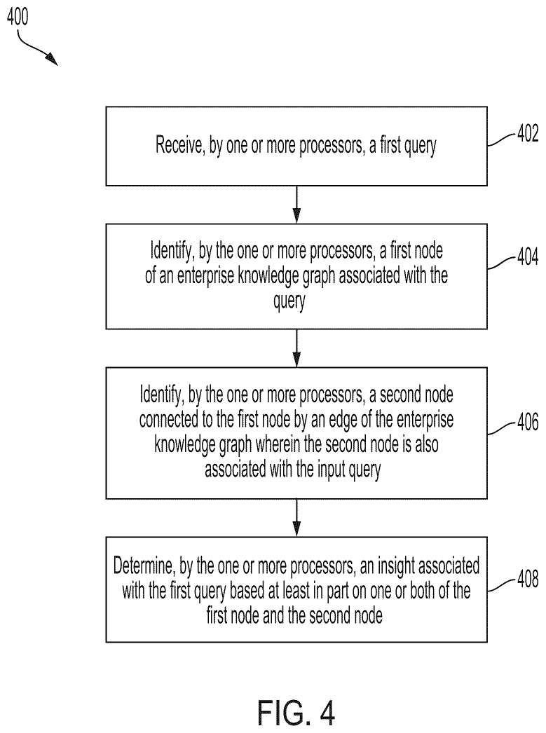

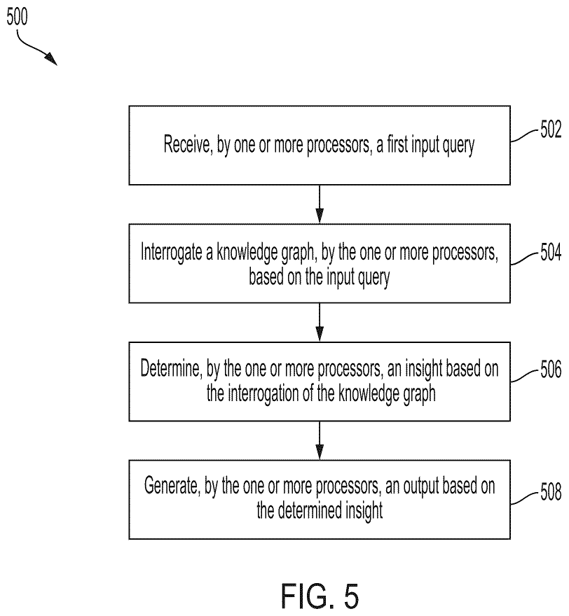

Determining the insight may include tracing a first node to a second node by following an edge linking the two nodes, the edge defining a relationship between the two nodes. For instance, determining an insight may comprise tracing a transaction using the enterprise knowledge graph. In some examples, the relationship may be a linguistic relator and, in the case of a financial statement knowledge graph, a first node may represent “equity” and a second node may represent “term” and the edge linking the first and second node may be the linguistic relator “is a” to represent that “equity is a term.” A third node representing “report” may be linked to the second node by an edge defined by linguistic relator “part of” such that tracing from the first node to the third node would produce the insight that equity is a term that is part of a report. Determining, by the one or more processors, the first insight may additionally or alternatively include performing statistical analysis on one or more nodes of the knowledge graph, performing a clustering operation on one or more nodes of the knowledge graph, identifying one or more clusters or hyperclusters of nodes in the knowledge graph. The first insight may also be determined according to either of the method 400 illustrated in FIG. 4 or the method 500 illustrated in FIG. 5, as described further below.

The enterprise knowledge graph generated at step 210 may include a plurality of nodes, each node associated with an aspect of the enterprise and each traceable to a plurality of interconnected nodes associated with a respective aspect of the enterprise. As such each node may be traceable to other nodes associated with a distinct topic (e.g., financial statements, business processes, entity relationships, etc.) and those nodes may be linked by edges representing different types of relationships, wherein the relationships may differ based on the type of information represented in the respective portion of the enterprise knowledge graph. The relationship represented by the edges of the knowledge graph may be orthogonal to the type of knowledge associated with the respective nodes of the knowledge graph (whether it is conceptual, structural or behavioral). As such, deriving an insight from the knowledge graph may result in any number of potential insights based on the information and type of relationships represented in the enterprise knowledge graph.

For instance, the insight may include an identified relationship between a first entity and a second entity of the one or more entities. The insight may include a determination of a cash flow between one or more accounts, a categorization of financial data based on a parenthetical note associated with historical financial data, a determination of an information flow based on a business process, wherein the business process is associated with a respective node in the enterprise knowledge graph.

As described above, the common knowledge substrate allows auditors interacting with the graph to make informed decisions and formulate recommendations by tracking multiple evidence threads through the enterprise knowledge graph. One or more processors may be configured to interrogate the enterprise knowledge graph to generate one or more insights, audit strategies and recommendations, risk assessments, and so on. The enterprise knowledge graph can reveal insights about business processes, entity relationship structures, enterprise financial conditions, and so on. The enterprise knowledge graph may also reveal communities reflected by clusters of related individuals in close proximity within the enterprise knowledge graph. As such, the insights derived from the enterprise knowledge graph may allow auditors to form a more accurate and complete understanding of an enterprise based on the information contained therein.

After generating the knowledge graph at step 210 and determining an insight from the generated knowledge graph at step 212, the method 200 may proceed to step 214. Step 214 may include determining, by the one or more processors third set of data components based on the enterprise knowledge graph generated at step 212 and incorporating the third set of data components into the knowledge graph. Incorporating the third set of data components into the knowledge graph may include associating a node representing one or more respective components of the third set of data components with an existing node of the knowledge graph used to determine the third set of data components. The third set of data components may include a second derived component. The second derived component may include any of the exemplary first derived components described above with reference to step 206.

For instance, in some examples, the second derived component can include an enterprise risk profile (i.e., risk assessment) determined based on the generated knowledge graph. The enterprise risk profile may allow full traceability to the components in the risk profile in terms of the absolute performance, historical performance, comparison with respect to industry peers, talent pool (quality, quantity and trending) and innovation (quality, quantity and trending). The enterprise risk profile may be constructed based on information in the enterprise knowledge graph. For instance, the enterprise risk profile can be a combination of reputation risk, operational risk, strategic risk, etc. In the case of operational risk, the risk profile can be computed from the risk in the enterprise's business operations, including but not limited to order to cash, record to report, procure to pay, financial planning and analytics. For example, for order to cash, the risk can be computed based on the likelihood that the existence assertion, completeness assertion, cutoff assertion, accuracy assertion, and presentation assertion are violated. Each of these can be computed from the enterprise knowledge graph which can be traced to the processes and supporting evidence at the transaction level.

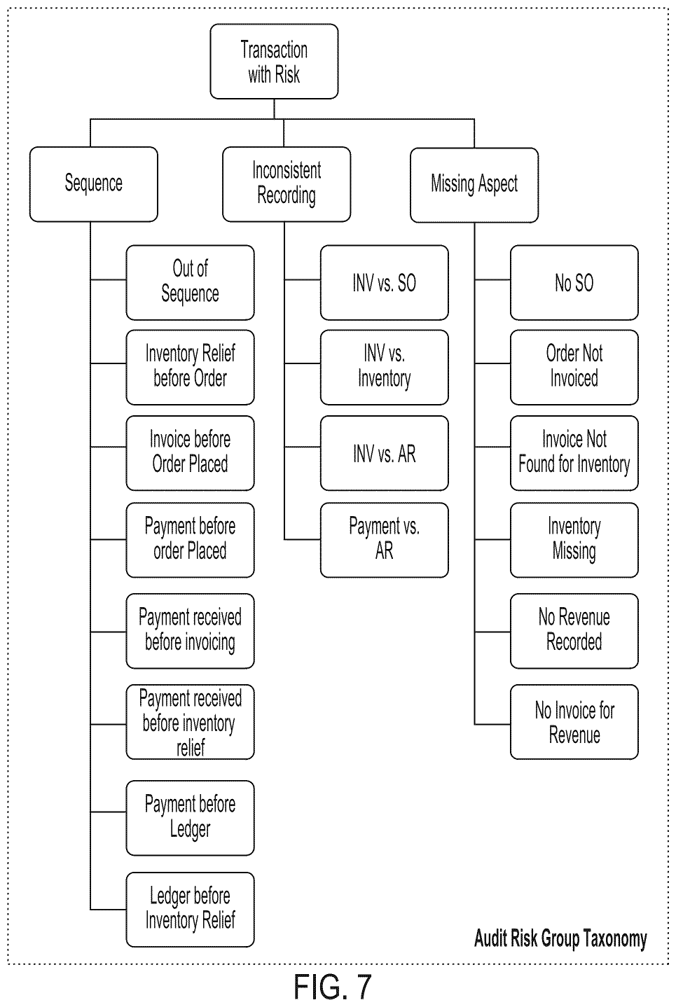

In some examples, the entity risk profile may be incorporated into the enterprise knowledge graph, as shown in FIG. 7. As shown in FIG. 7, a transaction with risk me be divisible into three primary subcategories: sequence, inconsistent recording, and missing aspect. Each of the three subcategories may be further divisible into various secondary subcategories, as shown in FIG. 7. For instance, within “missing aspect” the risk taxonomy may include subcategories for “no revenue recorded” or “no invoice for revenue,” each indicative of a risky transaction. As such, the entity risk profile can represent one or more risky transactions associated with an entity within the enterprise knowledge graph.

Returning to FIG. 2, after determining a third set of data components based on the knowledge graph and incorporating the third set of data components into the generated knowledge graph at step 214, the method 200 may proceed to step 216. Step 216 may include determining, by the one or more processors, a second insight using the generated knowledge graph. The second insight may be based on nodes representing the first, second, and third set of data components (i.e., the second insight may be based on nodes representing the input data, a first derived component determined based on the input data, and a second derived component determined based on the existing knowledge graph and incorporated into the existing knowledge graph). The second insight can be determined based on one or more nodes different from the one or more nodes used to determine the first insight. The second insight can also be determined based on one or more nodes that were used to determine the first insight. Determining the second insight at step 216 may also be accomplished according to the method 400 illustrated in FIG. 4 or the method 500 illustrated in FIG. 5, as described further below.

FIG. 3 illustrates a method 300 for progressively and continuously ingesting data to construct and/or augment a knowledge graph, for instance, the exemplary enterprise knowledge graph shown below in FIG. 5 and/or an enterprise knowledge graph generated according to the method 200 depicted in FIG. 2.

The method 300 illustrated in FIG. 3 may be used to progressively construct the conceptual, structural and behavioral aspects of the firm's enterprise knowledge graph. The conceptual, structural and behavioral aspects of the enterprise may be associated with more specific enterprise aspects, such as a financial aspect, a related entity aspect, a talent competency aspect, an innovation competency aspect, a visibility profile aspect, a customer sentiment aspect, and so on. Progressively constructing the conceptual, structural and behavior aspects of the firm's enterprise knowledge graph can include comparing data to an enterprise knowledge graph if the knowledge graph already exists and reconciling incremental discrepancies as needed.

The method 300 may include progressively constructing a financial aspect of the enterprise knowledge graph through historical SEC filings of the firm and its peers (of the same industry) and value chain(s) (suppliers and customers) (8K 10Q 10K) in XBRL (if public filings are available). The method 300 may include progressively constructing a related entity aspect (subsidiary, sibling firms, business partners) from public disclosure (including those disclosed on the company website). The method 300 may include progressively constructing a talent competency aspect of the enterprise knowledge graph from social media such as LinkedIn profiles of its employees and leadership (which is often on its own websites) as well as Glassdoor discussions of the company culture. The method 300 may include progressively constructing an innovation competency aspect of the enterprise knowledge graph from the worldwide patent filings of the firm (if available) to infer the trust culture within the firm. The method 300 may include progressively constructing a visibility profile aspect of the enterprise knowledge graph through social listening (analysis of the tweets and various postings on social media). The method 300 may include progressively constructing a customer sentiment analysis aspect of the enterprise knowledge graph through detailed analysis from product/service support forums and pertinent social media.

The method 300 may begin at step 302. Step 302 can include receiving, by one or more processors, input data of any one or more of a first, second, and third data modality. The data of the first data modality may include structured data (e.g., relational database (RDB), comma separated value (csv), xlsx, etc.), data of the second data modality may include semi-structured data (e.g., EDI, XML), and data of the third data modality may include unstructured data (e.g., text documents, pdf, etc.). The input data received at step 302 may include any of the data described above with reference to the method 200 illustrated in FIG. 2.

The enterprise knowledge graph may include nodes associated with various aspects of the enterprise (e.g., a financial aspect, a related entity aspect, a talent competency aspect, an innovation competency aspect, a visibility profile aspect, a customer sentiment aspect, and so on). As such, the data received by the one or more processors at step 302 may be associated with any one or more of the aforementioned enterprise knowledge graph aspects. For instance, as noted above, data from social media such as LinkedIn profiles of an enterprise's employees and leadership may be associated with a talent competency aspect of the enterprise knowledge graph. Such data may additionally or alternatively be associated with a legal or hierarchical structural aspect of the enterprise knowledge graph, representing, for instance, an employee or leadership chart of the enterprise.

After receiving input data of any one or more of a first, second, and third data modality at step 302, the method 300 may proceed to step 304. Step 304 can include optionally preprocessing, by the one or more processors, the data according to one or more preprocessing steps. For instance, unstructured data may be subject to named entity recognition, entity reconciliation, and relationship extraction. Named entity recognition can identify the entities that will be of interest, entity reconciliation can ensure that an entity is recognized even if referred to by multiple names, and relationships between entities can be extracted, for instance, in terms parent-subsidiary, vendor, customer, shipper, etc. Preprocessing the data, by the one or more processors, at step 304 may include determining, by the one or more processors, one or more derived components based on the received data. The one or more derived components may include any of those described above with reference to FIG. 2. According to some examples, the one or more processors may be configured to determine what kind of data a given data point is (e.g., whether input data is associated with behavioral, structural, and/or conceptual aspects of the enterprise), and may process the data in accordance with the determined data category.

According to one or more examples, preprocessing the data at step 304 may include applying one or more normalization and contextualization operations to some or all of the received data and may thereby generate normalized and/or contextualized output data. A normalization and contextualization data processing operation may determine context of an entity and/or may normalize an entity value so that it can be used for subsequent comparison or classification. Examples include (but are not limited to) the following: normalization of customer name data (such as alias, abbreviations, and potentially including parent/sibling/subsidiary when the name is used in the context of payment) based on master customer/vendor data; normalization of address data (e.g., based on geocoding, based on standardized addresses from a postal office, and/or based on customer/vendor data); normalization of product name and SKU based on master product data; normalization of shipping and payment terms based on terms (e.g., based on International Commerce Terms); and/or normalization of currency exchange code (e.g., based on ISO 4217).

After optionally preprocessing, by the one or more processors, the data according to one or more preprocessing steps at step 304, the method 300 may proceed to step 306. Step 306 can include generating and/or augmenting an enterprise knowledge graph. Generating the enterprise knowledge graph may proceed substantially according to the method described with reference to FIG. 2. As described above, each node of the enterprise knowledge graph may refer to a type of knowledge, potentially at the conceptual, structural or behavioral level. At the conceptual level, a node could refer to another knowledge graph or a set of business rules. At the structural level, a node could refer to an entity relationship graph that indicates the relationships between/among entities. At the behavioral level, a node could refer to a business process or a workflow or a dataflow. Each node may be associated with the input data received at step 302 and/or one or more of the one or more derived components determined at step 304. For instance, a first node may be associated with a first component of the input data and a second node may be associated with one of the derived components determined based on the first component of the input data. The first and second nodes may be associated with each other based on an identified relationship between the first and second nodes. The relationship may be represented by an edge of the knowledge graph.

Augmenting, by the one or more processors, a knowledge graph at step 306 may include continuously and progressively incorporating into an existing knowledge graph input data received by the one or more processors at step 302 and/or the derived components determined based upon the input data at step 304 by associating the aforementioned data and derived components with a node of the existing enterprise knowledge graph. As described above, augmenting the knowledge graph may include continuously and progressively constructing various aspects of the knowledge graph (e.g., a financial aspect, a related entity aspect, a talent competency aspect, an innovation competency aspect, a visibility profile aspect, a customer sentiment aspect, and so on).

FIG. 4 illustrates an exemplary method 400 for interrogating a knowledge graph to determine an insight based on the knowledge graph. In some examples, the method 400 may begin at step 402, wherein step 402 includes receiving, by one or more processors, a first query to determine an insight based on the knowledge graph. The input query may be a natural language input query. The input query may be a question associated with a respective enterprise represented by an enterprise knowledge graph. The input query may be associated with an audit process (e.g., vouching, tracing, reconciling, and so on).

After receiving the query at step 402, the method 400 may proceed to step 404, wherein step 404 includes identifying, by the one or more processors, a first node of the knowledge graph associated with the query. The one or more processors may identify a first node of the knowledge graph associated with the query using one or more keyword matching processes, semantic embedding matching processes, or any other technique for selecting a relevant node of a knowledge graph based on an input query.

After identifying a first node of the knowledge graph associated with the query at step 404, the method 400 may proceed to step 406, wherein step 406 includes identifying, by the one or more processors, a second node connected to the first node by and edge of the knowledge graph, wherein the second node is also associated with the query. The second node may be identified based on a relationship between the first node and the second node and/or by any one or more of the aforementioned matching processes used to identify the first node associated with the input query at step 404.

After identifying a second node connected to the first node, wherein the second node is also associated with the query at step 406, the method 400 may proceed to step 408, wherein step 408 includes determining, by the one or more processors, an insight associated with the first query based on at least in part on one or both of the first node and the second node. For instance, the insight may be determined by tracing an edge connecting the first and second node from the first node to the second node. The insight may be generated according to one or more statistical analyses performed on the first and second node, one or more clustering techniques, and/or any other method for determining an insight using a knowledge graph. It should be understood that the use of “first” and “second” node as described above is meant to be exemplary and not limiting. The process for determining an insight may comprise traversing any number of interconnected nodes of a knowledge graph.

The insight determined at step 408 may be associated with one or more enterprise structures or processes represented in the knowledge graph. The insight may be associated with an ongoing audit and/or used for planning or executing an audit strategy. The insight may be associated with a materiality or risk assessment and/or financial report preparation and validation. The insight may also include an explanation of how various insights were determined by the one or more processors, for instance, it may include a line of reasoning explanation and/or an indication of the origin of all facts and rules used to determine those insights.

FIG. 5 illustrates an additional exemplary method for interrogating a knowledge graph to determine an insight based on the knowledge graph. In some examples, the method 500 can begin at step 502. Step 502 may include receiving, by one or more processors, a first input query. The input query may be a natural language input query. The input query may be a question associated with a respective enterprise represented by an enterprise knowledge graph. The input query may be associated with an audit process (e.g., vouching, tracing, reconciling, and so on).

After receiving the first input query at step 502, the method 500 may proceed to step 504. Step 504 may include interrogating a knowledge graph, by the one or more processors, based on the input query. Interrogating the knowledge graph may include identifying one or more nodes associated with the input query (e.g., by one or more of the processes described above for matching an input query to a node with reference to FIG. 4), and tracing edges connecting the one or more nodes wherein the edges represent relationships between the nodes. Interrogating the knowledge graph may include performing one or more statistical analyses using one or more nodes associated with the input query, identifying one or more clusters or hyperclusters of nodes associated with the input query, and so on.

After interrogating the knowledge graph at step 504, the method 500 may proceed to step 506. Step 506 may include determining, by the one or more processors, an insight based on the interrogation of the knowledge graph at step 504. As discussed above with reference to FIG. 4, the insight determined at step 506 may be associated with an ongoing audit and/or used for planning or executing an audit strategy. The insight may be associated with a materiality or risk assessment and/or financial report preparation and validation. The insight may also include an explanation of how various insights were determined by the one or more processors, for instance, it may include a line of reasoning explanation and/or an indication of the origin of all facts and rules used to determine those insights.

After determining an insight at step 506, the method 500 may proceed to step 508. Step 508 may include generating, by the one or more processors, an output based on the determined insight. The output may include a natural language output, an audio output, a graphical display, or any other output capable of being generated by one or more processors based on an insight determined by interrogating a knowledge graph.

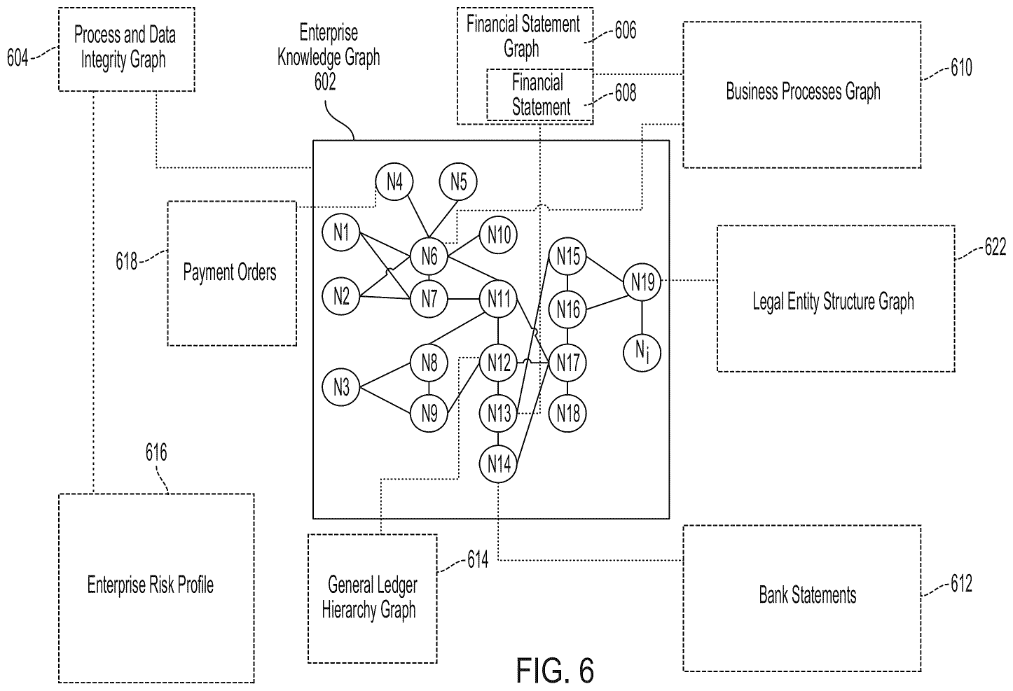

FIG. 6 illustrates an exemplary enterprise knowledge graph 602 in accordance with some embodiments. The enterprise knowledge graph comprises a plurality of nodes N1, N2 . . . N19 . . . . Nᵢ. Each node of the enterprise knowledge graph may represent a respective aspect of the enterprise. The nodes of the enterprise knowledge graph may represent a financial aspect, a related entity aspect, a talent competency aspect, an innovation competency aspect, a visibility profile aspect, a customer sentiment aspect, and so on to include all of the behavioral, structural, and conceptual knowledge associated with the enterprise.

According to an exemplary embodiment, the enterprise knowledge graph illustrated in FIG. 6 may be an enterprise knowledge graph constructed according to an OTC and Revenue Audit. Each of nodes (N1, N2 . . . . N19 . . . . Nᵢ) may represent the following:

| Node | Node Representation |
|---|---|
| N1 | Incoterms 2021 |
| N2 | Customer Master |
| N3 | Inventory |
| N4 | Sales Invoice |
| N5 | Sales Order |
| N6 | Order to Cash |
| N7 | Accounts Receivable Process |
| N8 | Warehouse Management |
| N9 | Logistics |
| N10 | Product Master |
| N11 | Order Management |
| N12 | General Ledger Taxonomy |
| N13 | General Ledger Trial Balance |
| N14 | Payments |
| N15 | Accounts Payable Process |
| N16 | Procure-to-Pay |
| N17 | Procurement |
| N18 | Advanced Planning |
| N19 | Vendor Master |

As shown, one or more of the respective nodes of the enterprise knowledge graph may represent and/or be associated with/traceable to nodes representing different aspects of the enterprise, for instance, data components extracted from data ingested from exogenous and endogenous data sources, structural, behavioral, and conceptual knowledge components determined based upon the data and extracted data components, and derived components as described throughout that are contained within the comprehensive enterprise knowledge graph. For instance, N4, the Sales Invoice node may be associated with various data components, such as one or more payment orders 618. N6, the order to cash node may be associated with a business processes 610. N12, the General Ledger Taxonomy node may be associated with a General Ledger Hierarchy 614, which represents various levels within a chart of accounts (e.g., the first level may comprise assets, liabilities, and other financial statement categories, the second level may comprise subcategories such as fixed assets, current assets, and so on). N13, the General Ledger Trial Balance node may be associated with a Financial Statement Graph 606 which is in turn associated with a Financial Statement 408. As shown, the Financial Statement Graph 606 may also be associated with a Business Processes Graph 410, which is in turn associated with the Order-to-Cash node, N6. N14, representing Payments may be associated with underlying payment data in the form of bank statements 612.

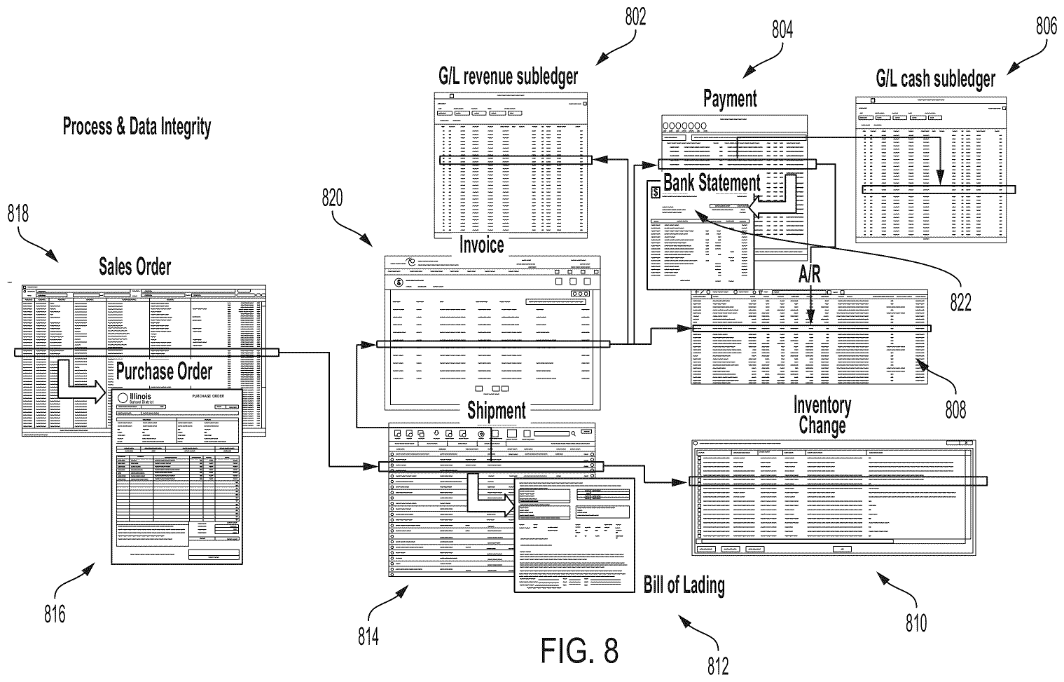

As described above with regard to FIG. 1, the enterprise knowledge graph 602 may include derived components, including an enterprise risk profile 616 (shown in detail in the risk profile depicted in FIG. 7). The enterprise risk profile 616 may be derived from information included in the enterprise knowledge graph and incorporated into the existing enterprise knowledge graph. For instance, the enterprise risk profile 616 may be derived based on a plurality of components included in the process and data integrity graph 604. For instance, the enterprise risk profile 616 may be derived by tracing a transaction through the components of the process and data integrity graph 604 to identify characteristics of the transaction indicative of risk. The process and data integrity graph 604 may comprise a graph illustrating various relationships between sales orders 818, purchase orders 816, invoices 820, shipments 814 and bills of lading 812, inventory changes 810, accounts receivable 808, a revenue subledger 802, a cash subledger 806, payments 804, and bank statements 822, as shown in FIG. 8. Tracing a transaction may involve tracing nodes representing data associated with each of the process and data integrity graph 604 components listed above.

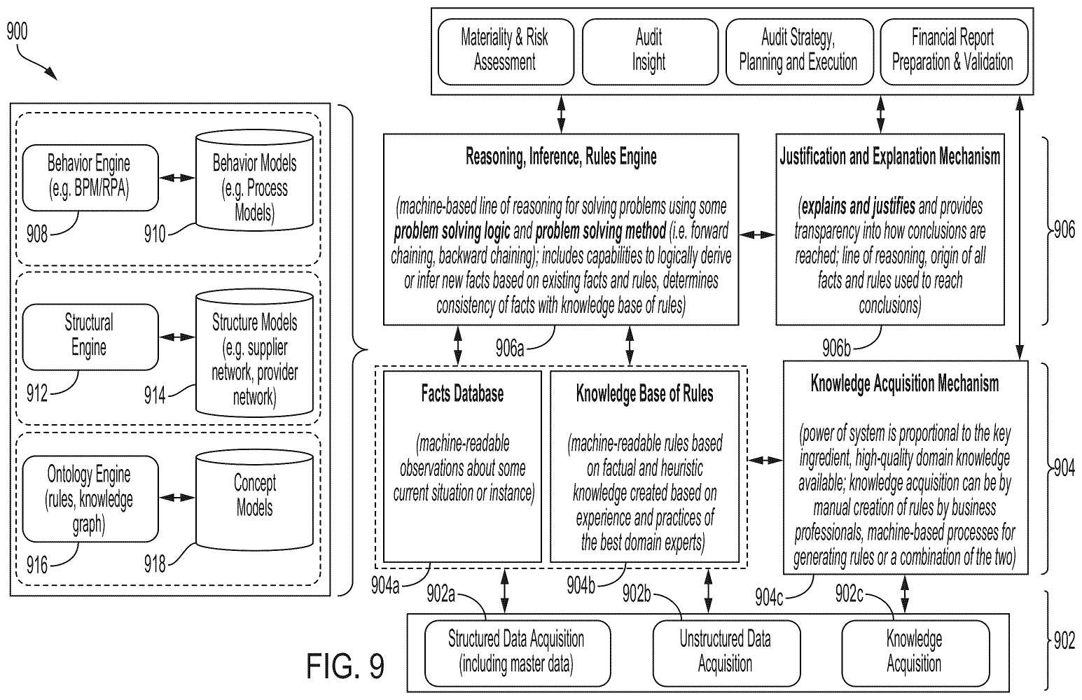

FIG. 9 illustrates how the common knowledge substrate including the enterprise knowledge graphs disclosed herein can be integrated into an overall auditing ecosystem 900. As shown the knowledge substrate orchestration layer 904 (i.e., the enterprise knowledge graph generation layer) sits between the data acquisition suite layer 902 and the audit insight orchestration layer 906. The data acquisition suite layer 902 may include one or more processors configured to acquire data from one or more data sources, for instance, data source 902a which includes structured data (including master data) and 902b which includes unstructured data (e.g., pdf, text documents, etc.).

The knowledge substrate layer 904 may include one or more processors and one or more data stores. Knowledge substrate layer 904 may include one or more processors configured to receive data from one or more data sources in the data acquisition suite layer 902 and process said data to generate processed endogenous/exogenous knowledge data, including, for example client specific data (e.g., master data), industry specific data (e.g., industry ontology), general data (e.g., shipping terms, FX, MIDA), and policy and rules data (e.g., ASC 606). The one or more processors of the knowledge substrate layer may include behavior engines 908 associated with one or more behavior models 910, structural engines 912 associated with one or more structure models 914, and ontology engines 916 associated with one or more concept models 918. The behavior engines 908 may include an engine that can interpret the knowledge representation such as a Business Process Management engine that can interpret a business process model. The structural engine 912 can include a graph engine that can interpret the relationship between business entities (subsidiary, parent, etc.). An ontology engine 916 that can interpret knowledge representation for ontology (such as based on OWL standard) can be a graph engine or tuple engine. A conceptual model engine can include a rule engine when the knowledge representation is business rules or a graph engine when the knowledge representation is a knowledge graph.

The behavior models, structure models, and concept models may be communicatively coupled to a facts database 904a and a knowledge base of rules 904b. The facts database 904a may include machine-readable observations about a current situation or instance. Machine readable observations can be in the form of csv, json or xml where the interpretation of data is unambiguous. The knowledge base of rules may include machine-readable rules based on factual and heuristic knowledge created based on the experience and practices of domain experts. The facts database 904a and knowledge base of rules 904b may be communicatively coupled to a knowledge acquisition mechanism 904c. The knowledge acquisition mechanism 904c may be configured to construct a knowledge graph from available knowledge sources (including human). The graph can be constructed manually, semi-automatically, or fully automatically. In other words, knowledge acquisition is the interface between the knowledge substrate and the outside world. Knowledge acquisition can transform the knowledge contained in a data corpus or from a human into knowledge representations in the knowledge substrate. The acquisition can be performed manually, semi-automatically or fully automatically.

As such, the one or more processors of the knowledge substrate layer may be configured to receive data from one or more data sources in the data acquisition suite layer 902 and generate one or more enterprise knowledge graphs comprising the data received and processed from the data acquisition suite layer 902, for instance, as described above with reference to FIGS. 1-3.

The audit insight orchestration layer 906 may include one or more processors configured to receive data from the knowledge substrate layer 904, for instance one or more enterprise knowledge graphs, and derive or infer new facts based on existing facts and rules, determine consistency of facts within the knowledge base of rules, generate one or more audit insights, one or more audit strategies, and/or generate/validate one or more financial reports based on the data received from the knowledge substrate layer. For instance, the one or more processors of the audit insight orchestration layer 906 may be configured to determine one or more spatial or temporal insights, one or more spatiotemporal insights, one or more process insights, and/or one or more attribute insights (e.g., customer, product) based on the data received from the knowledge substrate layer 904.

The audit insight orchestration layer 906 may include a reasoning, inference, and rules engine 906a and a justification and explanation mechanism 906b. The reasoning, inference, and rules engine 906a may include one or more processors configured to execute a machine readable program for performing one or more auditing operations (e.g., forward chaining, backward chaining), the program including capabilities to logically derive or infer new facts based on existing facts and rules. The justification and explanation mechanism 906b may include one or more processors configured to execute a machine-readable program for explaining/justifying conclusions generated by the reasoning, inference, and rules engine 906a. For instance, the justification and explanation mechanism 906b may provide line of reasoning explanation, indication of factual origin, and indication of rules used to reach various conclusions.

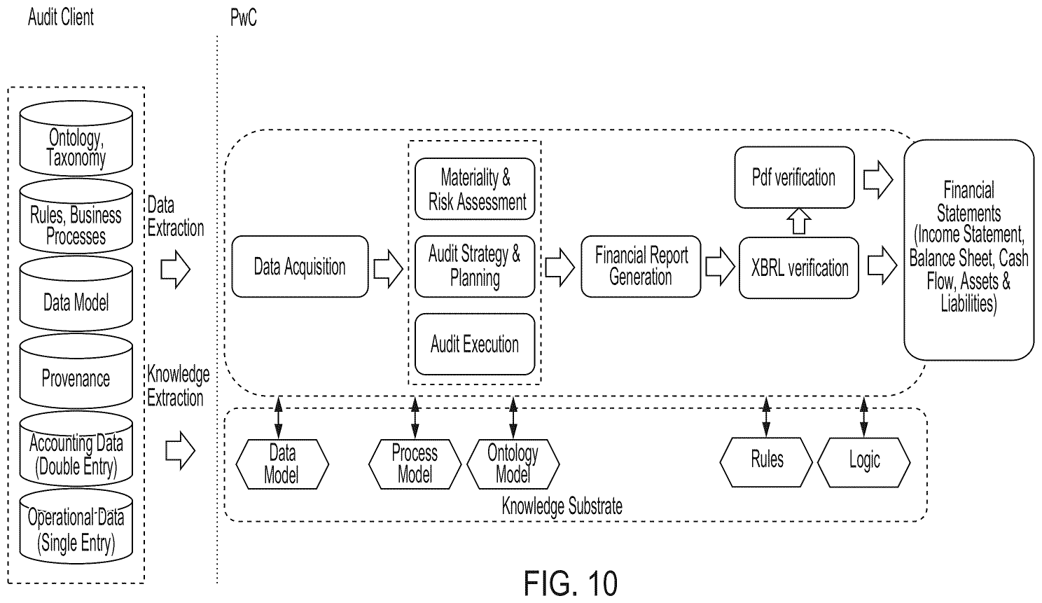

FIG. 10 illustrates how the auditing and/or risk assessment process draws on knowledge from a common knowledge substrate. For instance, FIG. 10 shows that when an audit client shares a common knowledge representation with an auditor (such as the chart of account hierarchy), the auditor will not have to reconstruct the chart of account hierarchy simply from account number and account name (which is often the case) but can instead draw on the common knowledge.

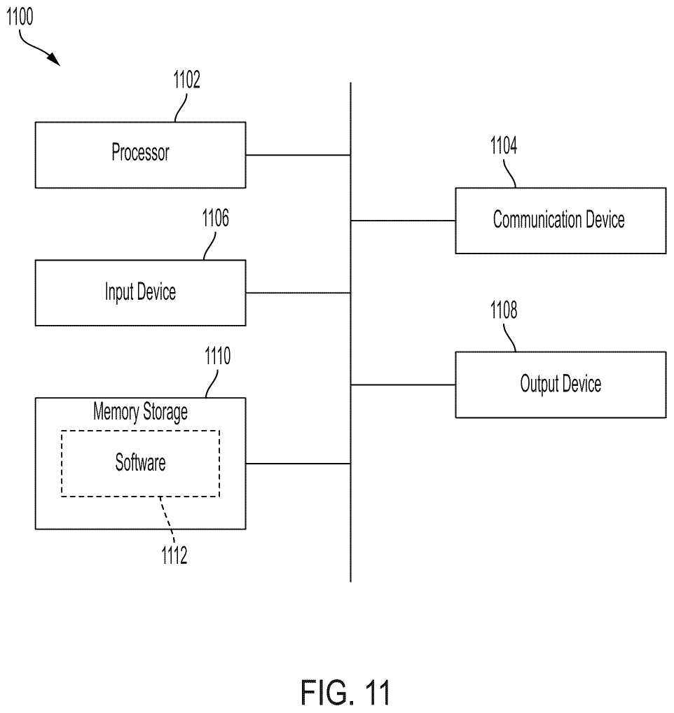

FIG. 11 depicts an exemplary computing device 1100, in accordance with one or more examples of the disclosure. Device 1100 can be a host computer connected to a network. Device 1100 can be a client computer or a server. As shown in FIG. 11, device 1100 can be any suitable type of microprocessor-based device, such as a personal computer, workstation, server, or handheld computing device (portable electronic device) such as a phone or tablet. The device can include, for example, one or more of processors 1102, input device 1106, output device 1108, storage 1110, and communication device 1104. Input device 1106 and output device 1108 can generally correspond to those described above and can either be connectable or integrated with the computer.

Input device 1106 can be any suitable device that provides input, such as a touch screen, keyboard or keypad, mouse, or voice-recognition device. Output device 1108 can be any suitable device that provides output, such as a touch screen, haptics device, or speaker.

Storage 1110 can be any suitable device that provides storage, such as an electrical, magnetic, or optical memory, including a RAM, cache, hard drive, or removable storage disk. Communication device 1104 can include any suitable device capable of transmitting and receiving signals over a network, such as a network interface chip or device. The components of the computer can be connected in any suitable manner, such as via a physical bus or wirelessly.

Software 1112, which can be stored in storage 1110 and executed by processor 1102, can include, for example, the programming that embodies the functionality of the present disclosure (e.g., as embodied in the devices as described above).

Software 1112 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1110, that can contain or store programming for use by or in connection with an instruction execution system, apparatus, or device.

Software 1112 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 1100 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 1100 can implement any operating system suitable for operating on the network. Software 1112 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

The invention claimed is:

1. A method for generating a knowledge graph, the method comprising:
receiving, by one or more processors, first input data comprising a first set of data components related to one or more entities from one or more data sources;
determining, by the one or more processors, based upon the first input data, a second set of data components;
identifying, by the one or more processors, one or more relationships between the first set of data components and the second set of data components; and
generating a knowledge graph comprising a plurality of nodes, wherein a first node of the knowledge graph represents a first respective data component of the first set of data components and a second node of the knowledge graph represents a second respective data component of the second set of data components, and wherein the first node is associated with the second node, the association defined by one or more of the identified one or more relationships.

2. The method of claim 1, wherein the second set of data components comprises a first derived component derived based on a first processing operation performed using the first input data.

3. The method of claim 2, wherein the first derived component comprises an entity risk profile associated with a first entity, the entity risk profile determined based on the first input data.

4. The method of claim 3, wherein the entity risk profile is constructed based on any one or more of structural knowledge associated with the first entity, conceptual knowledge associated with the first entity, and behavioral knowledge associated with the first entity.

5. The method of claim 2, wherein the first processing operation comprises a financial audit operation performed using the first input data.

6. The method of claim 1, further comprising: determining a third set of data components, wherein the third set of data components comprises the result of a second processing operation performed using the generated knowledge graph; and incorporating the third set of data components into the generated knowledge graph.

7. The method of claim 6, wherein the second processing operation is different from the first processing operation.

8. The method of claim 6, further comprising: determining an insight from the generated knowledge graph, wherein the insight is based on nodes representing the first set of data components, the second set of data components, and the third set of data components.

9. The method of claim 1, wherein the first set of data components comprises any one or more of: financial statements, sales orders, subsidiary entity lists, supplier lists, customer lists, employee lists, competitor lists, patent filings, trademark filings, social media posts, purchase orders, sales orders, bills of lading, bank statements, general ledger records, inventory lists, invoices, shipment records, accounts receivable records, accounts payable records, social media posts, and SEC filings.

10. The method of claim 1, further comprising: determining an insight from the generated knowledge graph, wherein the insight is based on nodes representing the first set of data components and the second set of data components.

11. The method of claim 1, wherein the first input data comprises data of one or more data modalities, the one or more data modalities comprising an unstructured data modality, a semi-structured data modality, and a structured data modality.

12. The method of claim 1, wherein the one or more relationships comprise a one-to-one mapping of all or a subset of all of the first set of data components and the second set of data components.

13. The method of claim 1, wherein the one or more relationships comprise a one-to-many mapping of all or a subset of all of the data components of the first set of data components and the second set of data components.

14. The method of claim 1, wherein the one or more relationships comprise a many-to-one mapping of all or a subset of all of the data components of the first set of data components and the second set of data components.

15. The method of claim 1, wherein the one or more relationships comprise a many-to-many mapping of all or a subset of all of the data components of the first set of data components and the second set of data components.

16. The method of claim 1, wherein the first node of the knowledge graph refers to one or more of structural knowledge associated with a first entity of the one or more entities, conceptual knowledge associated with the first entity, and behavioral knowledge associated with the first entity.

17. The method of claim 16, wherein the conceptual knowledge associated with the first entity comprises taxonomies and ontologies associated with the first entity.

18. The method of claim 16, wherein the structural knowledge associated with the first entity comprises a legal structure of one or more of the first entity and one or more entities related to the first entity.

19. The method of claim 16, wherein the behavioral knowledge associated with the first entity comprises one or more business processes associated with the first entity.

20. The method of claim 1, wherein an entity of the one or more entities is any one of an individual, a business entity, or a government entity.

21. The method of claim 1, further comprising:
receiving second input data related to the one or more entities from the one or more data sources;
identifying one or more relationships between the second input data and a node of the generated knowledge graph; and
updating the knowledge graph by incorporating the second input data, wherein incorporating the second input data comprises associating the second input data with the node of the generated knowledge graph based on the identified one or more relationships between the second input data and the node of the generated knowledge graph.

22. The method of claim 1, wherein the first input data comprises a first set of rules associated with a structure of a first entity and a second set of rules associated with a process of the first entity.

23. A system for generating a knowledge graph, the system comprising one or more processors configured to cause the system to:
receive, by one or more processors, first input data including a first set of data components related to one or more entities from one or more data sources;
determine, by the one or more processors, based upon the first input data, a second set of data components;
identify, by the one or more processors, one or more relationships between the first set of data components and the second set of data components; and
generate a knowledge graph comprising a plurality of nodes, wherein a first node of the knowledge graph represents a first respective data component of the first set of data components and a second node of the knowledge graph represents a second respective data component of the second set of data components, and wherein the first node is associated with the second node, the association defined by one or more of the identified one or more relationships.

24. A non-transitory computer readable storage medium storing instructions for generating a knowledge graph, the instructions configured to be executed by a system comprising one or more processors to cause the system to:
receive, by one or more processors, first input data including a first set of data components related to one or more entities from one or more data sources;
determine, by the one or more processors, based upon the first input data, a second set of data components;
identify, by the one or more processors, one or more relationships between the first set of data components and the second set of data components; and
generate a knowledge graph comprising a plurality of nodes, wherein a first node of the knowledge graph represents a first respective data component of the first set of data components and a second node of the knowledge graph represents a second respective data component of the second set of data components, and wherein the first node is associated with the second node, the association defined by one or more of the identified one or more relationships.

25. A method for interrogating a knowledge graph, the method comprising:
receiving, by one or more processors, an input query,
interrogating, based on the input query, a knowledge graph, wherein the knowledge graph comprises a plurality of nodes, wherein a first node of the knowledge graph represents a first respective data component of a first set of data components and a second node of the knowledge graph represents a second respective data component of a second set of data components, wherein the second set of data components comprises a derived component derived based on a first processing operation performed using one or more data components of the first set of data components, and wherein the first node is associated with the second node, the association represented by one or more relationships identified between the respective first data component and the second respective data component.

26. The method of claim 25, further comprising determining an insight from interrogating the generated knowledge graph, wherein the insight is based on one or more nodes respectively representing the first set of data components and one or more nodes respectively representing the second set of data components.

27. The method of claim 25, wherein interrogating the knowledge graph comprises performing a statistical analysis on one or more of the plurality of nodes of the knowledge graph.

28. The method of claim 25, wherein interrogating the knowledge graph comprises identifying one or more clusters of nodes in the knowledge graph.

29. The method of claim 28, wherein the one or more clusters of nodes are associated with one or more communities of individuals represented in the knowledge graph.

30. The method of claim 28, wherein the one or more clusters of nodes are associated with one or more related transactions represented in the knowledge graph.

31. The method of claim 25, further comprising generating an output based on interrogating the knowledge graph, wherein output comprises a risk assessment.

32. The method of claim 25, further comprising generating an output based on interrogating the knowledge graph, wherein output comprises an audit strategy.

33. The method of claim 25, wherein the first set of data components comprises data from one or both of an endogenous data source and an exogenous data source, and wherein the first set of data components is associated with a first entity of the one or more entities.

34. The method of claim 25, wherein the first processing operation comprises an audit operation using one or more data components of the first set of data components.

35. The method of claim 25, wherein one or more of the plurality of nodes refers to one of structural knowledge associated with a first entity, conceptual knowledge associated with the first entity, and behavioral knowledge associated with the first entity.

36. The method of claim 35, wherein the structural knowledge comprises an entity relationship graph that indicates one or more relationships between the first entity and one or more different entities.

37. The method of claim 35, wherein the conceptual knowledge comprises one or more rules associated with the first entity.

38. The method of claim 35, wherein the behavioral knowledge comprises one or more business processes associated with the first entity.

39. A system for interrogating a knowledge graph, the system comprising one or more processors configured to cause the system to:
receive, by one or more processors, an input query,
interrogating, based on the input query, a knowledge graph, wherein the knowledge graph comprises a plurality of nodes, wherein a first node of the knowledge graph represents a first respective data component of a first set of data components and a second node of the knowledge graph represents a second respective data component of a second set of data components, wherein the second set of data components comprises a derived component derived based on a first processing operation performed using one or more data components of the first set of data components, and wherein the first node is associated with the second node, the association represented by one or more relationships identified between the respective first data component and the second respective data component.

40. A non-transitory computer readable storage medium storing instructions for interrogating a knowledge graph, the instructions configured to be executed by a system comprising one or more processors to cause the system to:
receive, by one or more processors, an input query,
interrogating, based on the input query, a knowledge graph, wherein the knowledge graph comprises a plurality of nodes, wherein a first node of the knowledge graph represents a first respective data component of a first set of data components and a second node of the knowledge graph represents a second respective data component of a second set of data components, wherein the second set of data components comprises a derived component derived based on a first processing operation performed using one or more data components of the first set of data components, and wherein the first node is associated with the second node, the association represented by one or more relationships identified between the respective first data component and the second respective data component.
